(19) United States
(12) Patent Application Publication
(10) Pub. No.: US 2024/0293919 A1
(43) Pub. Date: Sep. 5, 2024

(54) ANGLE-ADJUSTABLE RATCHET TOOL

(71) Applicant: Thomas Jefferson University, Philadelphia, PA (US)

(72) Inventor: Jennifer Hegelein, Southampton, NJ (US)

(21) Appl. No.: 18/593,283

(22) Filed: Mar. 1, 2024

Related U.S. Application Data
(60) Provisional application No. 63/488,360, filed on Mar. 3, 2023.

(51) Int. Cl. B25B 23/00; B25B 21/00

(52) U.S. Cl. CPC B25B 23/0028; B25B 21/004

(57) ABSTRACT

An angle-adjustable ratchet tool comprises a body comprising a handle portion, comprising a connection to an energy source, and a switch connected to the energy source, a motor housing portion rotatably attached to the handle portion at a hinge point, the motor housing portion comprising a motor connected to the energy source, and a head mechanically connected to the motor and having a tip, the tip oriented to rotate about an axis orthogonal to an axis of rotation of the motor, wherein the switch is configured to provide energy to the motor from the energy source when the switch is pressed, and wherein the motor housing portion is configured to rotate at the hinge point with respect to the handle portion at a total angle of travel of at least ±20°.

### CROSS-REFERENCE TO RELATED APPLICATIONS

This application claims priority to U.S. Provisional Patent Application No. 63/488,360, filed on Mar. 3, 2023, incorporated herein by reference in its entirety.

### BACKGROUND OF THE INVENTION

Pneumatic and electric ratchets are among the tools used by engineers and mechanics to loosen or tighten bolts and fasteners in a variety of mechanical applications, including automotive and industrial settings. Typical electric and pneumatic ratchets have a linear, right-angled design, for example as shown in FIG. 1A and FIG. 1B. These ratchets, while simple and sturdy, lack the ability to adjust the angle between the grip of an operator and the bolt or fastener being loosened or tightened. This can lead to awkward positioning for the operator (see e.g. FIG. 1C), which can in turn cause ergonomic disorders and repetitive stress injuries. Carpal tunnel syndrome, for example, is caused by compression of the median nerve due to strain or repetitive wrist movements, which can cause pain and numbness.

Thus, there is a need in the art for an ergonomic and angle-adjustable tool suitable for use in various applications.

### SUMMARY OF THE INVENTION

In one aspect, an angle-adjustable ratchet tool comprises a body comprising a handle portion, comprising a connection to an energy source and a switch connected to the energy source, a motor housing portion rotatably attached to the handle portion at a hinge point, the motor housing portion comprising a motor connected to the energy source, and a head mechanically connected to the motor and having a tip, the tip oriented to rotate about an axis orthogonal to an axis of rotation of the motor, wherein the switch is configured to provide energy to the motor from the energy source when the switch is pressed, and wherein the motor housing portion is configured to rotate at the hinge point with respect to the handle portion at a total angle of travel of at least ±20°.

In one embodiment, the switch comprises a trigger configured to rotate about a hinge point fixedly attached to the handle portion. In one embodiment, the handle portion further comprises at least one button configured to prevent the motor housing portion from rotating about the hinge point when the at least one button is in a locked position, and to allow the motor housing portion to rotate about the hinge point when the at least one button is in an unlocked position. In one embodiment, the energy source is a battery. In one embodiment, the battery is a rechargeable, removable battery.

In one embodiment, the device further comprises a directional switch positioned on the head. In one embodiment, the directional switch is configured to change the direction of rotation of the motor. In one embodiment, the motor is an alternating-current or direct-current electric motor. In one embodiment, the motor is a pneumatically actuated motor and the energy source is a source of pressurized gas. In one embodiment, the device further comprises at least one grip element positioned on the handle portion.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A, FIG. 1B, and FIG. 1C show prior art ratchet tools.

FIG. 2A shows a top view of an exemplary ratchet tool.

FIG. 2B shows a side view of an exemplary ratchet tool, further showing a range of rotation.

FIG. 2C shows an exploded view of an exemplary ratchet tool.

FIG. 3A and FIG. 3B show diagrams of grip angles for an exemplary ratchet tool.

FIG. 3C shows grip angles using a prior art ratchet tool.

FIG. 4A is a top view line drawing of an exemplary ratchet tool.

FIG. 4B is a bottom view line drawing of an exemplary ratchet tool.

FIG. 4C is a side view line drawing of an exemplary ratchet tool.

FIG. 4D is a perspective view of an exemplary ratchet tool illustrating the internal components of the ratchet tool.

FIG. 4E is a detail view of a hinge portion of an exemplary ratchet tool.

FIG. 4F is a detail view of a switching mechanism of an exemplary ratchet tool.

FIG. 5A is a side view of a handle portion of an exemplary ratchet tool.

FIG. 5B is a top view of a handle portion of an exemplary ratchet tool.

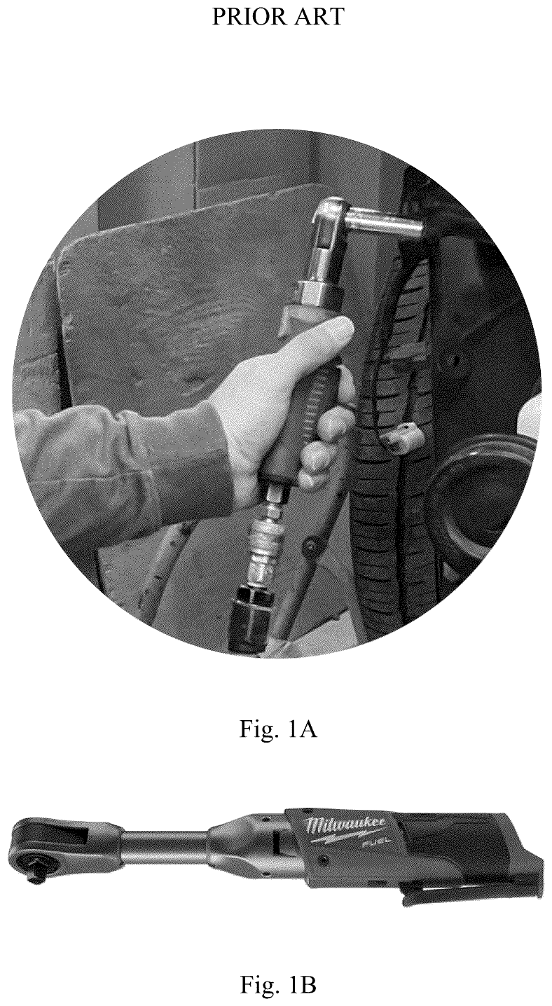

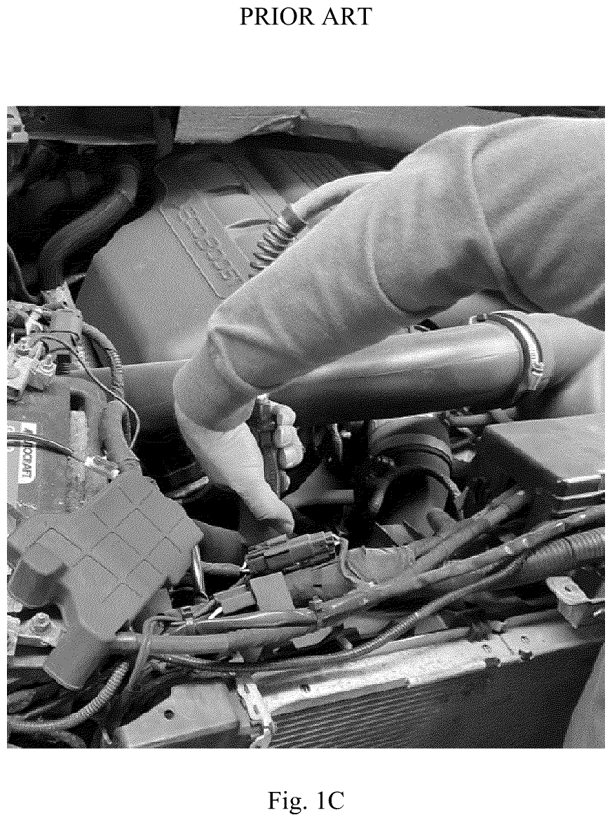

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

Although certain embodiments of the disclosure may be described herein as referring to a particular electric or pneumatic tool, it is understood that certain design elements and aspects of the disclosure may be applied equally to a wide variety of electrically or pneumatically actuated tools, including but not limited to ratchets, impact drivers, buffers, grinders, drills, chipping hammers, sanders and wrenches.

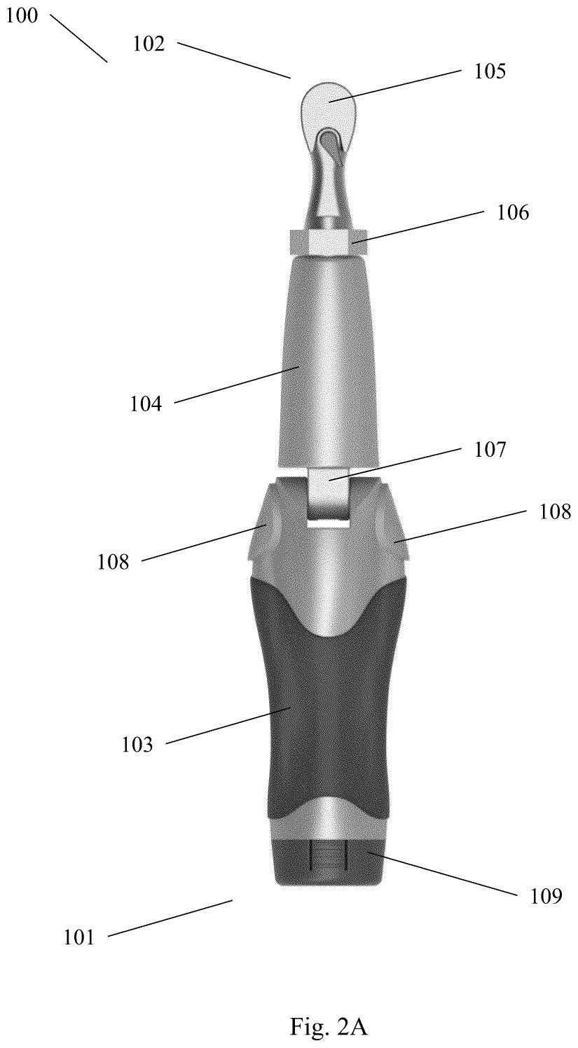

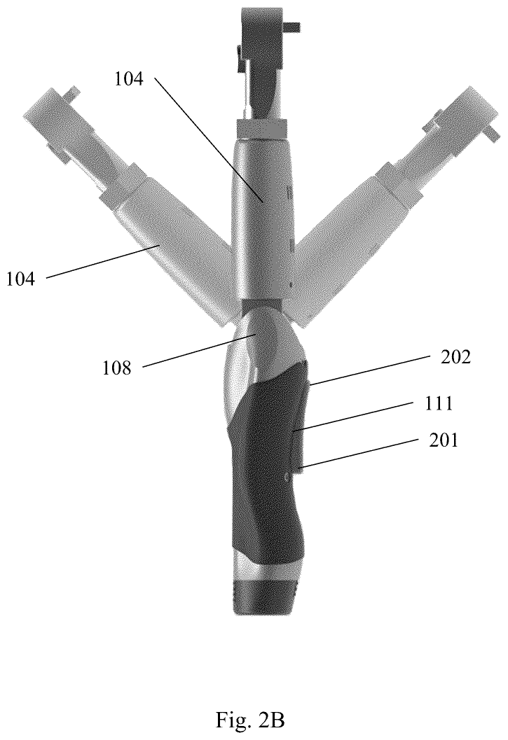

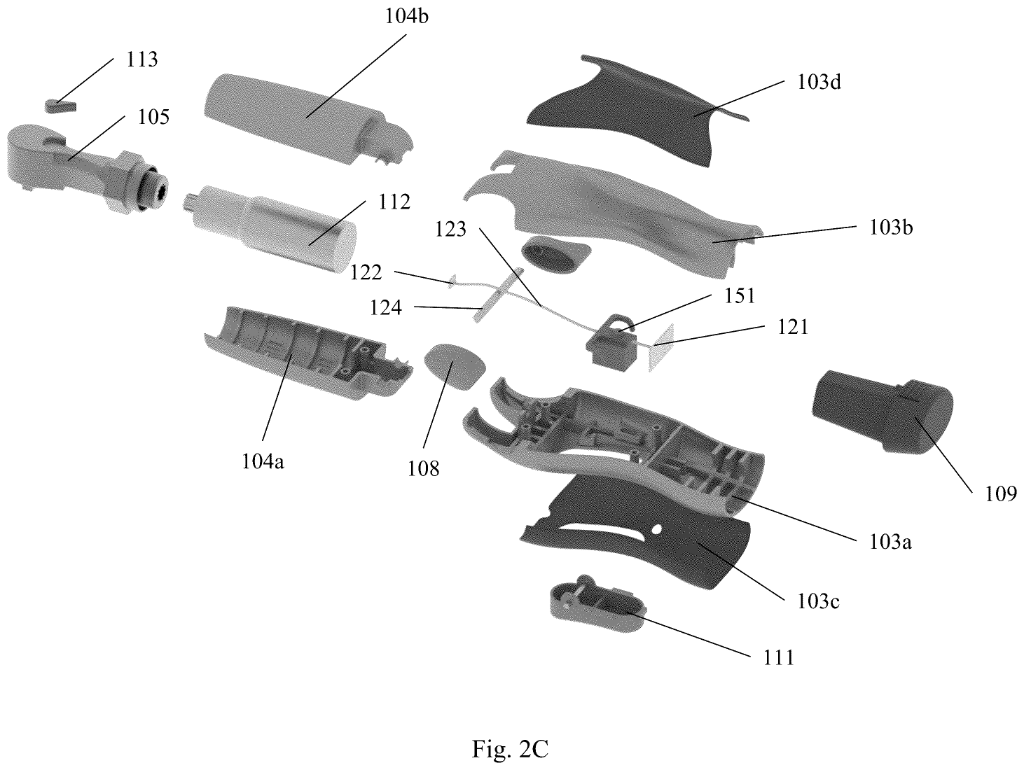

With reference to FIG. 2A, a top view of an exemplary ratchet tool 100 is shown having a proximal end 101 and a distal end 102. The depicted embodiment includes a body having a handle portion 103 and a motor housing portion 104 rotatably attached to the handle portion 103, for example via locking hinge or pin 107. In certain embodiments, ratchet tool 100 includes one or more buttons or control elements 108, for example positioned on the side of handle portion 103 of ratchet tool 100, configured to lock the handle portion 103 to a certain angle with respect to the motor housing portion 104 when the button 108 is released, and to allow the motor housing portion to freely rotate about locking hinge 107 when one or more of the buttons 108 are pressed (see e.g. FIG. 2B).

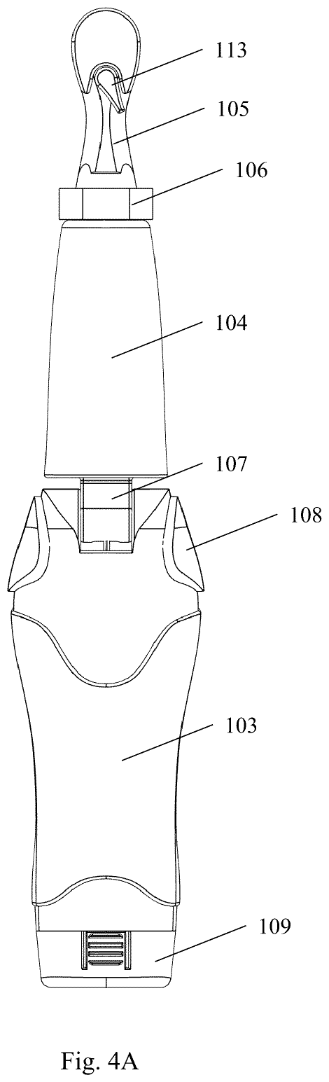

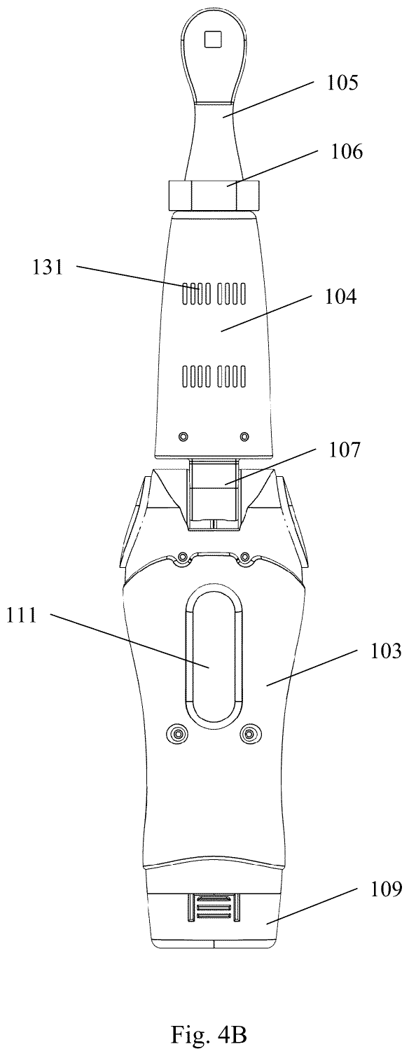

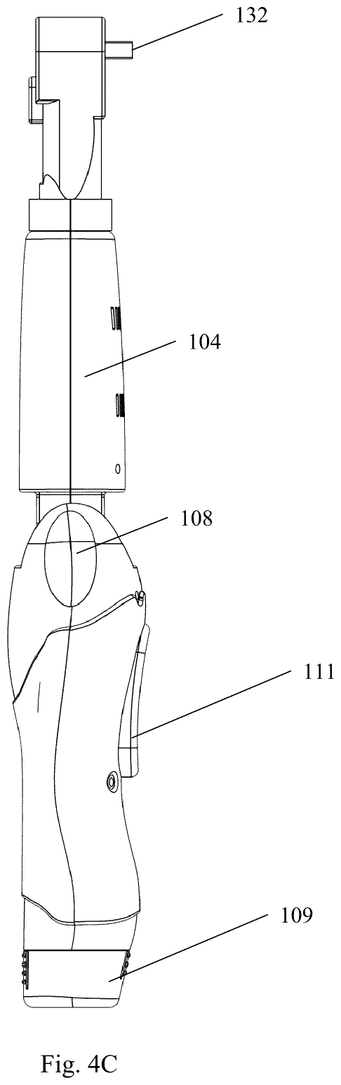

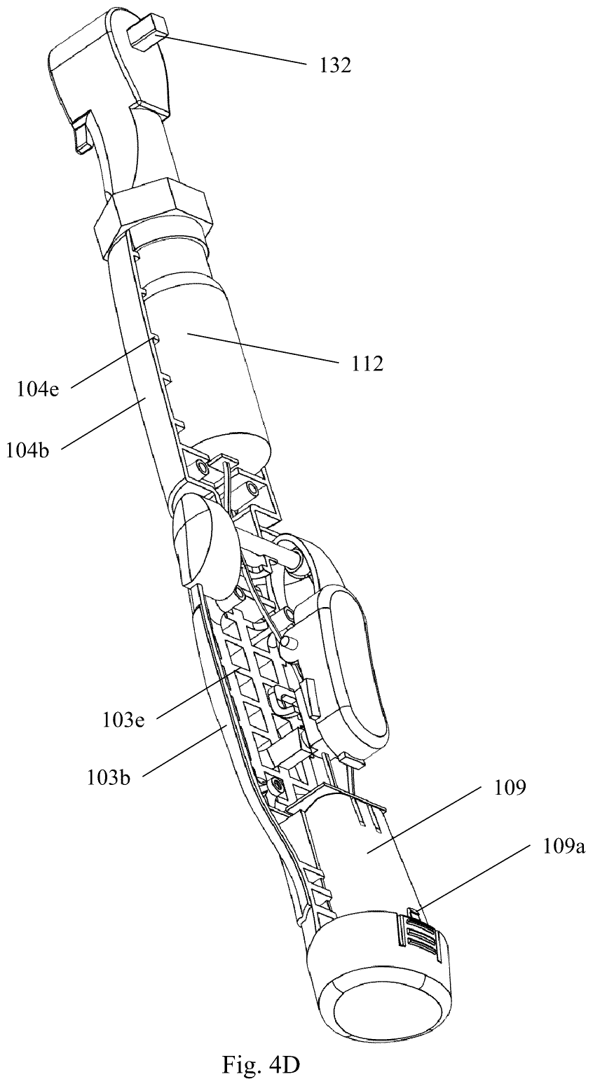

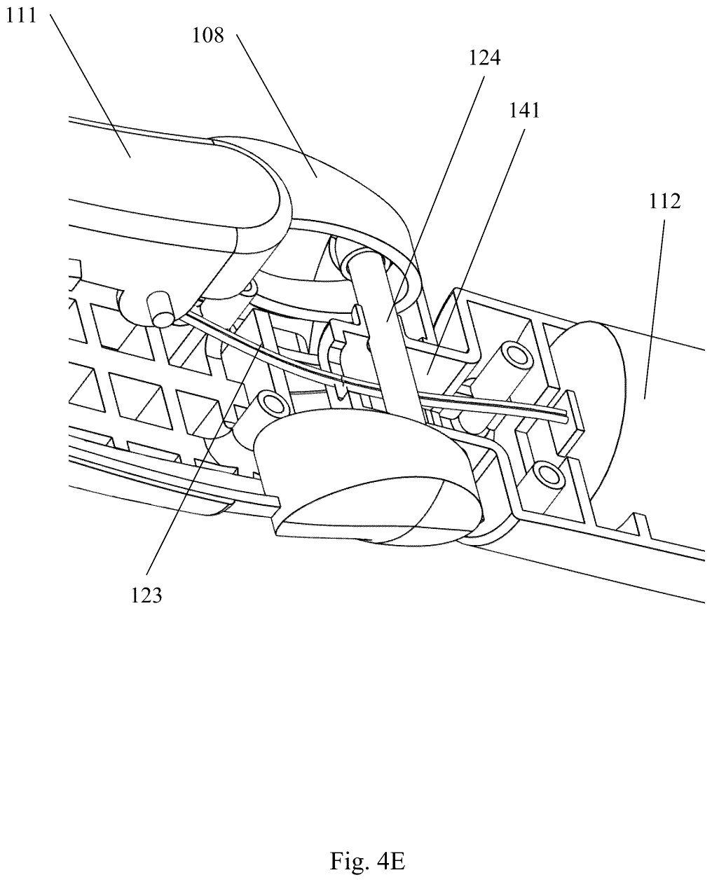

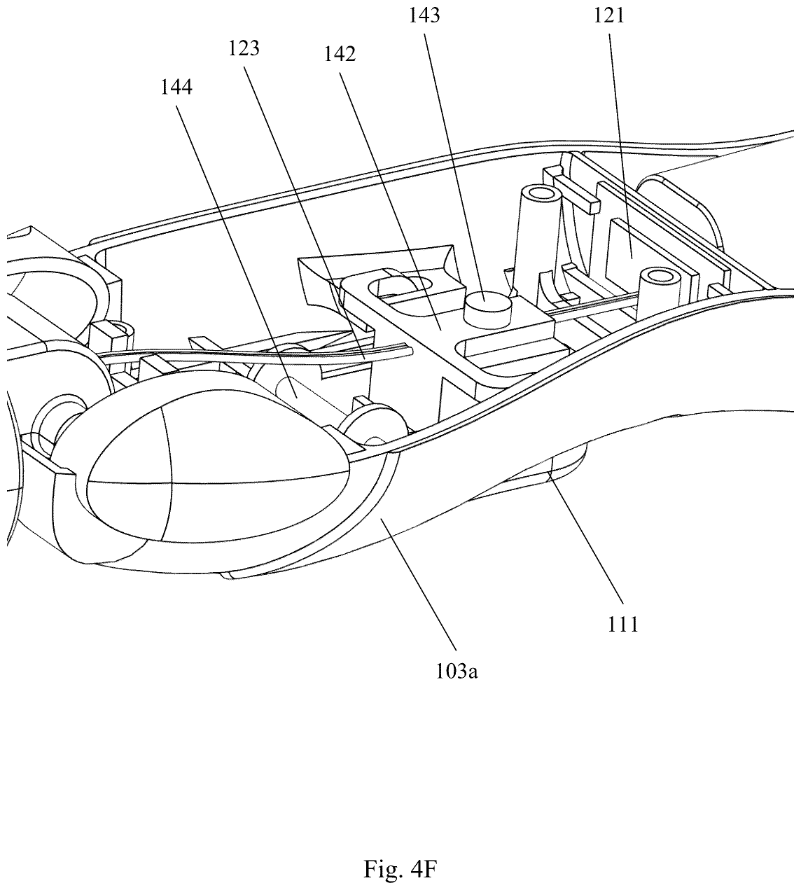

The ratchet tool 100 may further comprise a head 105 positioned at the distal end 102, and a battery 109 positioned at the proximal end 101. In some embodiments the head 105 may be removably attached to motor housing portion 104, for example via a snapping or locking mechanism 106 to allow for interchangeability of the head 105. In some embodiments, the head 105 may comprise a ratchet head or a socket head, for example suitable for receiving ½″ or ⅜″ drive sockets or compatible elements. In some embodiments, head 105 may comprise a gearbox, for example a translating gearbox configured to translate a rotational energy of the motor 112 (see FIG. 2C) at some angle, for example 90 degrees, to tip 132 (see FIG. 4C). In some embodiments, motor housing portion 104 and/or head 105 may comprise a gearbox configured to increase a torque of the tip 132, for example by reducing the rotational speed of tip 132 with respect to the rotational speed of motor 112.

In some embodiments battery 109 may comprise a rechargeable, lithium-ion, lithium-polymer, or nickel-metal hydride battery. In some embodiments the battery 109 may be removably attached to handle portion 103, for example via a clip, while in other embodiments, the battery 109 may be fixedly positioned within handle portion 103. The handle portion 103 may comprise electrical contacts configured to electrically connect to corresponding contacts in battery 109 when battery 109 is inserted into handle portion 103. In some embodiments, handle portion 103 may comprise an electrical connector (not shown) for example configured to receive direct-current or alternating-current electricity and charge the battery 109. In such embodiments, the handle portion 103 may further comprise power management and/or charging circuitry configured to regulate the power delivered to and/or discharged by the battery 109.

With reference to FIG. 2B, an exemplary diagram showing a total angular range of motion for a ratchet tool 100 is shown. In the depicted embodiment, when one or more side buttons 108 are pressed, the motor housing portion 104 may rotate freely about an axis positioned at the intersection of the handle portion 103 and the motor housing portion 104. In certain embodiments, the total angle of travel may be ±90°, ±80°, ±70°, ±60°, ±50°, ±45°, ±40°, ±35°, ±30°, ±25°, ±20°, or any other suitable angle of travel.

Also shown in FIG. 2B is trigger 111, positioned along the bottom side of handle portion 103. The trigger 111 may be configured to be depressed at a first end, for example proximal end 201, while being attached to handle portion 103 at distal end 202, for example via a pin or hinge. In other embodiments, trigger 111 may take the form of a button, for example a toggle or momentary contact button, positioned below a flexible sheath fixedly attached at its edges to handle portion 103. Such a design may for example allow for the device 100 to remain sealed against dirt or liquid, while still allowing for actuation of the underlying button. The trigger 111 (or button) may in some embodiments be configured to electrically connect the battery or a regulated voltage provided by the battery to a motor positioned within motor housing portion 104, which in turn rotates or otherwise actuates the head.

With reference to FIG. 2C, an exploded view of an exemplary device is shown. The exemplary device shows one embodiment of a handle portion and a motor housing portion split into two interlocking or connectable parts, 103a and 103b for the handle portion and 104a and 104b for the motor housing portion. The two interlocking parts may be configured to connect via any suitable method, for example clips or fasteners. In some embodiments, the handle portion 103 and/or the motor housing portion 104 may further comprise a gasket, for example comprising rubber or a polymer, positioned along the edges of the two interlocking parts, configured to form a seal within the individual elements of the device to prevent dirt or liquid from entering the inside of the device housing.

In the depicted embodiment of FIG. 2C, the handle portion 103 further comprises grip elements 103c and 103d. In some embodiments, the grip elements may be produced having a different color than the remainder of the device housing, for example to indicate to an operator where the best place is to hold the ratchet tool 100.

In the depicted embodiment of FIG. 2C, the head 105 further comprises a directional ratchet switch 113, which may in some embodiments function similarly to the corresponding switch on a socket wrench, latching the head such that it will prevent rotation of the tip 132 (see FIG. 4C) in one direction (clockwise or counterclockwise), but allow rotation in the opposite direction. In some embodiments, directional ratchet switch 113 functions to stop rotation of the tip 132 in one or the other direction when the body of the device itself is manually rotated (for example when an operator is using the ratcheting tool without the motor, as a socket wrench). In other embodiments, the directional ratchet switch 113 may be electrically connected to first or second circuit board 121 or 122, and may function to switch the direction of rotation of motor 112, and in turn the direction of rotation of tip 132 when trigger 111 is depressed.

Also shown in the exploded view of FIG. 2C are internal components, for example motor 112 positioned within motor housing portion 104 and switch 151, configured to be mechanically actuated by trigger 111 and to provide motor 112 with power from battery 109. In some embodiments, switch 151 interrupts one or more connections within connecting wire 123, which connects first circuit board 121 with second circuit board 122.

In some embodiments, motor 112 may comprise an alternating current (AC) or direct-current (DC) electric motor, for example a brushed or brushless DC motor. In some embodiments, the motor 112 may be a pneumatically-actuated motor. In embodiments where motor 112 is a pneumatically-actuated motor, connecting wire 123 and first and second circuit boards 121 and 122 may be replaced or supplemented by a pneumatic air channel (not shown) configured to selectively deliver pressurized air to the pneumatically-actuated motor.

The first circuit board 121 is configured to interface with battery 109, and may comprise power conditioning and/or power management circuitry. In some embodiments, first circuit board 121 further comprises power monitoring circuitry and/or a processor configured to periodically measure a voltage across terminals of battery 109, and configured to display, for example via one or more LEDs or an LCD indicator, an estimated battery level of battery 109. Second circuit board 122 may comprise circuitry necessary to control motor 122, for example relays or other circuitry necessary to adjust the polarity of power delivered to motor 122, in order to control its direction of rotation, for example allowing an operator to switch between loosening or tightening a bolt.

Finally, as shown in the exploded view of FIG. 2C, the handle portion 103 and the motor housing portion 104 may be joined together via a hinge or pin 124 configured to define the axis of rotation demonstrated in FIG. 2B. In some embodiments, hinge or pin 124 may comprise a metal, for example stainless steel, titanium, aluminum, or any other suitable metal. In other embodiments, hinge or pin 124 may comprise first and second interlocking parts molded into handle portion 103 and motor housing portion 104.

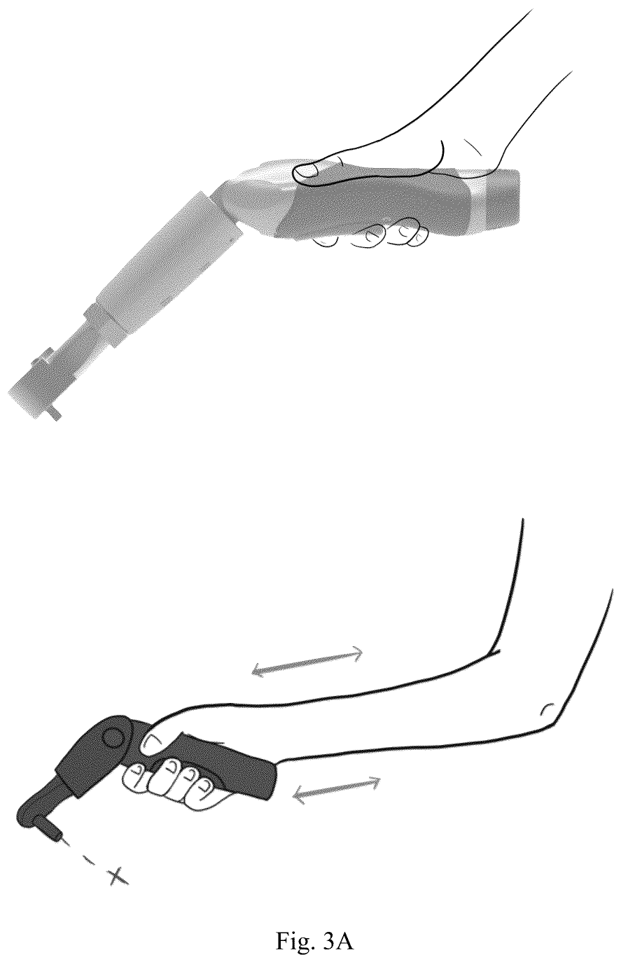

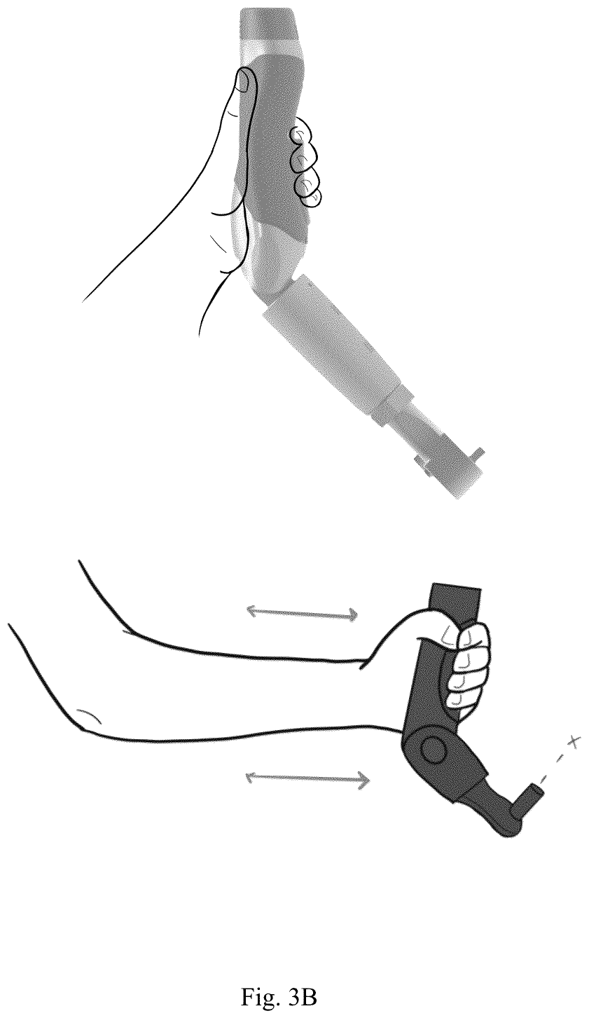

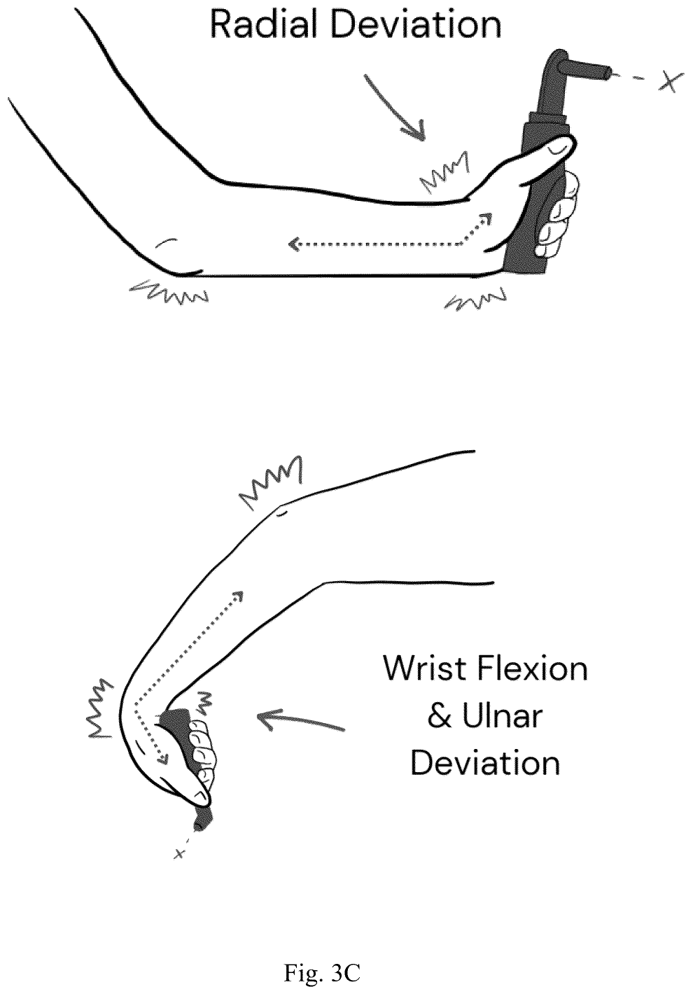

Advantageously, the disclosed design allows for operators to grip the ratchet tool in a much more natural and ergonomically comfortable or ergonomically neutral way. In an automotive application, for example, the disclosed design allows for increased operator comfort to tighten or loosen hard-to-reach bolts in cars. For example, as shown in FIG. 3A, an operator may hold the tool in an incline grip, or may alternatively, as shown in FIG. 3B, hold the tool in a pistol grip. As shown in FIG. 3C, the use of existing tools in these same environments leads to necessarily awkward gripping by the operator, due to the fixed angle between the operator's grip and the tool portion. The grip shown in the top half of FIG. 3C can lead to a radial deviation, while the grip shown in the bottom half of FIG. 3C leads to wrist flexion and ulnar deviation, both of which can lead to stress injuries. (see also Moore, et al., “Practical Demonstrations of Ergonomic Principles,” Centers for Disease Control and Prevention, https://www.cdc.gov/niosh/mining/userfiles/works/pdfs/2011-191.pdf, 2011, incorporated herein by reference in its entirety).

With reference to FIG. 4A, FIG. 4B, and FIG. 4C, top, bottom, and side line drawing views of an exemplary ratchet tool are shown, illustrating the same parts as outlined in FIG. 2A and FIG. 2B. As shown in FIG. 4A, in some embodiments, one or both of the handle portion 103 or the motor housing portion 104 may include ventilation holes 131, for example configured to dissipate heat from the motor, battery, or circuit elements during operation. With reference to FIG. 4D, an isometric view of an exemplary device is shown having one half of the handle portion housing and one half of the motor housing removed, exposing an exemplary internal layout. The depicted diagram shows an exemplary battery securing mechanism, flexible tab 109a, configured to retain the battery 109 in place within the handle portion but also allow for removal of battery 109 when the tab 109a is depressed.

Also visible in FIG. 4D are exemplary internal structural reinforcement elements 104e in the motor housing portion and 103e in the handle portion. The depicted device has a grid arrangement of structural elements in the handle portion and lateral elements 104e in the motor housing, configured to seat the motor snugly within the motor housing portion. In some embodiments, the motor may be fixedly attached to the motor housing portion, for example via welding or fasteners. In some embodiments, the motor housing portion is over-molded over part or all of the motor.

With reference to FIG. 4E, a detail view of a hinge portion of an exemplary device is shown, depicting the relative positions of trigger 111, hinge/pin 124, and wire 123 in an assembled device. As shown, the motor housing portion includes a channel 141 which surrounds wire 123 and also engages pin 124, while minimizing friction and wear from pin 124 on wire 123 as the motor housing portion 104 rotates with respect to handle portion 103.

A detail view of the opposite side of an exemplary device, with half of the handle portion 103 housing removed, is shown in FIG. 4F. The diagram of FIG. 4F shows one exemplary functional implementation of trigger 111, wherein trigger 111 rotates about an axis formed by pin 144 and in turn rotates clip 142 which includes push-button switch 143. Push-button switch 143 in turn is depressed by exerting pressure against rear housing portion 103b (not shown in FIG. 4F). The push button switch 143 closes a circuit between battery 109 and motor 112, thereby turning motor 112 and rotating the tip 132.

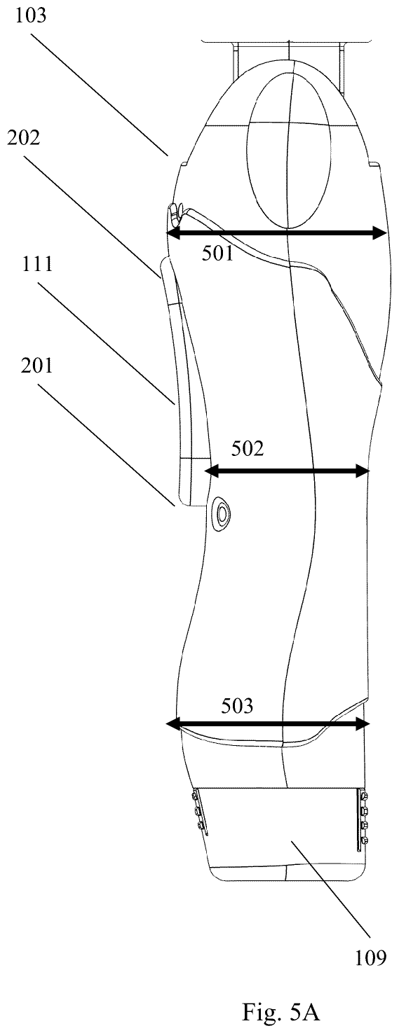

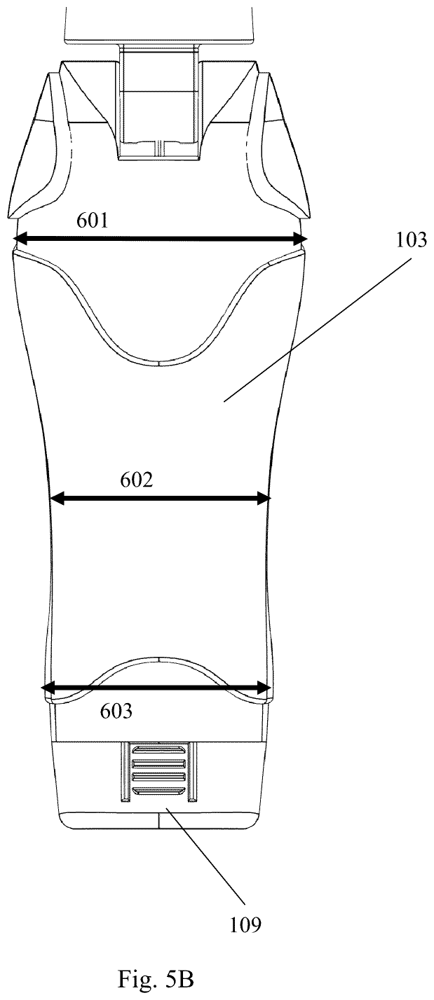

With reference to FIG. 5A, a side view of an exemplary handle portion is shown. As described briefly above, one advantageous aspect of the disclosed device is the ergonomic design, wherein the handle portion 103 includes a first depth 501 at a point near the distal end 202 of trigger 111, and a second, narrower depth 502 at a position near proximal end 201 of trigger 111. In some embodiments, the second depth 502 may be 5% less, 10% less, 15% less, 20% less, 25% less, 30% less, or any other value less than the first depth 501. In some embodiments, the difference between the first depth 501 and the second depth 502 may be adjustable, for example via removable/interchangeable grips 103c and 103d, for example in order to accommodate different sized hands or operator preference. The depicted geometry further comprises a third, wider depth 503 at a position near the proximal end of the handle portion, where the battery 109 is positioned. The third depth 503 may in some embodiments be the same or about the same as the first depth 501. In some embodiments, the third depth 503 may be wider than the first depth 501. In some embodiments, the third depth is the same as, 5% more than, 10% more than, 15% more than, 20% more than, 25% more than, 30% more than, or any other suitable value more than the second depth 502.

Similarly, as shown in the rear view of FIG. 5B, the device may in some embodiments be defined by first, second, and third widths 601, 602, and 603. Similarly to the depths 501, 502, and 503, some or all of the widths 601, 602, and 603 may be adjustable via removable/interchangeable grips 103c and 103d. In some embodiments, the first width 601, measured near the buttons or control elements 108, may be wider than the second width 602, measured near the proximal end 201 of trigger 111. The second width may in some embodiments be 5% less, 10% less, 15% less, 20% less, 25% less, 30% less, or any other value less than the first width 601. The depicted geometry further comprises a third, wider width 603 at a position near the proximal end of the handle portion, where the battery 109 is positioned. The third width 603 may in some embodiments be the same or about the same as the first width 601 or may be the same or about the same as the second width 602. In some embodiments, the third width 603 may be wider than the first width 601. In some embodiments, the third width is the same as, 1% more than, 3% more than, 5% more than, 10% more than, 15% more than, 20% more than, or any other suitable value more than the second width 602.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. An angle-adjustable ratchet tool, comprising:
a body comprising:
a handle portion, comprising:
a connection to an energy source; and
a switch connected to the energy source;
a motor housing portion rotatably attached to the handle portion at a hinge point, the motor housing portion comprising:
a motor connected to the energy source; and
a head mechanically connected to the motor and having a tip, the tip oriented to rotate about an axis orthogonal to an axis of rotation of the motor;
wherein the switch is configured to provide energy to the motor from the energy source when the switch is pressed; and
wherein the motor housing portion is configured to rotate at the hinge point with respect to the handle portion at a total angle of travel of at least ±20°.

2. The angle-adjustable ratchet tool of claim 1, wherein the switch comprises a trigger configured to rotate about a hinge point fixedly attached to the handle portion.

3. The angle-adjustable ratchet tool of claim 1, wherein the handle portion further comprises at least one button configured to prevent the motor housing portion from rotating about the hinge point when the at least one button is in a locked position, and to allow the motor housing portion to rotate about the hinge point when the at least one button is in an unlocked position.

4. The angle-adjustable ratchet tool of claim 1, wherein the energy source is a battery.

5. The angle-adjustable ratchet tool of claim 4, wherein the battery is a rechargeable, removable battery.

6. The angle-adjustable ratchet tool of claim 1, further comprising a directional switch positioned on the head.

7. The angle-adjustable ratchet tool of claim 6, wherein the directional switch is configured to change the direction of rotation of the motor.

8. The angle-adjustable ratchet tool of claim 1, wherein the motor is an alternating-current or direct-current electric motor.

9. The angle-adjustable ratchet tool of claim 1, wherein the motor is a pneumatically actuated motor and the energy source is a source of pressurized gas.

10. The angle-adjustable ratchet tool of claim 1, further comprising at least one grip element positioned on the handle portion.
